(19) United States
(12) Patent Application Publication
(10) Pub. No.: US 2023/0117945 A1
(43) Pub. Date: Apr. 20, 2023

(54) METHOD AND DEVICE FOR PRODUCING WELDED REINFORCING MESHES WITH HIGH STRENGTH AND EXPANSION VALUES

(71) Applicant: EVG ENTWICKLUNGS- U. VERWERTUNGS-GESELLSCHAFT M.B.H., Raaba (AT)

(72) Inventor: Klaus RITTER, Graz (AT)

(21) Appl. No.: 17/905,836

(22) PCT Filed: Mar. 16, 2021
(86) PCT No.: PCT/IB2021/052182

§ 371 Date: Sep. 8, 2022

(30) Foreign Application Priority Data
Mar. 17, 2020 (AT) A 67/2020

(51) Int. Cl. B23K 11/00; B21F 27/10

(52) U.S. Cl. CPC B23K 11/008; B21F 27/10

(57) ABSTRACT

Method for the continuous production of mesh mats made of steel wire having a plurality of parallel longitudinal wires that are welded to transverse wires extending in a manner spaced apart from one another, wherein hot- or cold-rolled wire material is used as the longitudinal and transverse wires, wherein the longitudinal wires are stretched in a stretching apparatus while being fed to the welding operation, wherein the longitudinal wires are drawn through the stretching apparatus by means of a capstan drum, and wherein the transverse wire material is also stretched in a separate stretching apparatus while being fed to the welding operation, and an installation for carrying out the method.

### FIELD

The invention relates to a method for the continuous production of mesh mats made of steel wire having a bundle of parallel longitudinal wires that are welded to transverse wires extending in a manner spaced apart from one another, wherein hot- or cold-rolled wire material is used as the longitudinal and transverse wires. The invention also relates to an installation for the continuous production of mesh mats made of steel wire welded at the crossing points, with a pay-off device with a number of take-off drums corresponding to the plurality of parallel longitudinal wires which are fed to a welding machine in the form of a bundle, wherein the bundle can be fed to a welding machine in a horizontal guideway centrally arranged and symmetrically distributed around the central axis of the same, as well as with a pay-off device for the transverse wire material of the mesh, which can also be fed to the welding machine.

### BACKGROUND

Cold-drawn or cold-rolled ribbed wires, as well as ribbed hot-rolled wires, must preferably be used for the production of welded meshes for concrete reinforcement.

However, certain disadvantages are inherent in both types of materials.

To achieve the necessary strength (yield point), hot-rolled wires have a high carbon content, which does not permit subsequent resistance welding to form concrete reinforcement mats, since a martensitic microstructure would develop during the welding process, which would result in sufficient strength but insufficient ductility. In order to avoid an increased use of carbon above approx. 0.2% (permissible upper limit), alloy additions, such as of Vanadium or Niobium can be used, which are very expensive and make the welded mesh uneconomical. Thus, in order to ensure weldability, a lower carbon content must be provided, with which, however, the minimum standardized strengths cannot be achieved.

Cold-rolled wires have the disadvantage of excessive material compression, caused by the drawing-rolling process, and thus insufficient ductility of the wires.

The standards for welded wire mesh, such as EN 10080, prescribe a minimum yield limit of 500 N/mm² and a minimum elongation defined as Agt (elongation at maximum force) of 5%.

In order to overcome the disadvantages mentioned, a method and a mechanical device are proposed in which the wires supplied to the welding machine for mesh production have neither a high carbon content nor sufficient ductility. According to this method, as is known in the production of stretched individual wires, the wires are stretched in the longitudinal direction (stretching process), wherein on the one hand the strength of the hot-rolled wires with a low carbon content is increased to the required level and on the other hand the elongation properties of the cold-rolled wires are improved, in order to comply with the standard.

### SUMMARY

The object of the invention is to prevent these disadvantages. The method of the invention achieves this object in that the longitudinal wires are stretched in a stretching device while being fed to the welding process, wherein the longitudinal wires are drawn through the stretching device by means of a capstan drum, and wherein the transverse wire material is also stretched in a separate stretching device while being fed to the welding process.

In a further embodiment of the method, all the longitudinal wires form a bundle while being fed to the welding process, in which they are placed parallel to one another in a plane and simultaneously stretched in this arrangement in the stretching device. This has the advantage of already carrying out the stretching process in the longitudinal wire arrangement in which the wire mesh welding takes place.

In another embodiment, the transverse wire material is drawn through the stretching device by means of a take-off device.

It is also conceivable that the transverse wire material and the longitudinal wires are straightened after stretching.

A further embodiment of the method is characterized in that the stretching process taking place on the transverse wire material is carried out on wire held ready on two storage drums of a pay-off device, wherein the wire is alternately drawn off from the two storage drums used alternately and the free ends of the drawn off wire are welded, as is known per se, so that the stretching process takes place continuously on a continuous wire. In the time that the wire is being drawn off the second coil, a new full coil of wire can be placed at the first position. The end of the wire of the second coil is then welded to the beginning of the wire of the new coil, etc.

In a further embodiment, the stretched transverse wire material is guided through a compensating store and a deflection arc and is straightened only immediately before it is fed to a welding machine and is cut into the shape of the individual transverse wires. This has the advantage that the track of the transverse wire material occupies a compact space next to the installation, despite the presence of the stretching device and other elements.

The installation according to the invention for the continuous production of mesh mats made of steel wire welded at the crossing points achieves the objects in that the transverse wire material run off from the pay-off device can be fed to the region immediately in front of the welding machine in a separate guideway of the welding machine, wherein in the guideways of the longitudinal wires and of the transverse wire material a respective stretching device is arranged and wherein, viewed in the direction of motion of the longitudinal wires, behind the stretching device for the longitudinal wires, a capstan drum is arranged, through which the longitudinal wires can be drawn through the stretching device.

In another embodiment of the installation, the bending rollers of the stretching device for the transverse wire material can be adjusted, i.e. their relative positions to one another can be changed and temporarily fixed in order to adjust or intentionally to change the degree of stretching, depending on the material to be stretched, for example.

In another embodiment, the pay-off device for the transverse wire material comprises, as is known per se, two storage drums which are used alternately and a welding device for welding the ends of the transverse wire material alternately drawn off from the storage drums, so that the stretching process can be carried out on a continuous transverse wire material.

A further embodiment is characterized in that the guideway for the transverse wire material is arranged laterally offset up to immediately in front of the region of the welding machine and parallel to the horizontal guideway of the longitudinal wires.

In another embodiment of the invention, the take-off devices in the form of capstan drums are followed by a longitudinal wire conditioning or straightening device for the transverse wire material integrated in the transverse wire feeding device.

In a further embodiment of the installation, the stretching device for the longitudinal wires is preceded by a separate wire guide for each longitudinal wire, wherein for each longitudinal wire of the bundle a separate stretching unit is provided, with rollers successively engaging each longitudinal wire on opposite sides, which rollers are combined to form respective multiple rollers, in order to simultaneously apply the same tensile force to each longitudinal wire.

Another embodiment of the invention is characterized in that a device for cutting the transverse wire material into the individual transverse wires is integrated in the transverse wire feeding device.

### BRIEF DESCRIPTION OF THE DRAWINGS

The invention is explained below with reference to an embodiment shown in the drawings, wherein an overview of the installation according to the invention is shown schematically in:

FIG. 1 in a plan view;

FIG. 2 in an elevation;

FIG. 3 shows the path of the transverse wire in a plan view (detail from FIG. 1);

FIG. 4 shows the paths of the non-welded longitudinal wires in a plan view (detail from FIG. 1);

FIG. 5 shows the first initial part of the installation in a side view (detail from FIG. 2); and

FIG. 6 shows the second part of the installation in a side view (detail from FIG. 2). The proportions are illustrated by means of an example person 20 in FIG. 1.

### DETAILED DESCRIPTION

According to the proposed method, in a typical reinforcing mesh welding system, one or two transverse wires and the whole number of longitudinal wires of a mat are stretched simultaneously and together.

In the case of transverse wires, this takes place during the feeding of the transverse wires, wherein the transverse wire(s) is/are preferably drawn off from wire bundles vertically overhead and then pass through a stretching device 5 while being fed to a welding machine 10, with the tensile force being applied by a downstream take-off device 6. The stretched wire or wires is/are then guided through a compensating store 7 and drawn off from there by the welding machine 10 according to the work cycle of the entire system, then introduced into the welding line, welded into mats, cut to length and stacked.

A plurality of longitudinal wires 2, typically 25 longitudinal wires are drawn off together on the inlet side from individual wire reels 21 and then run through a corresponding number of individual stretching devices 13 (in the horizontal and/or vertical plane), wherein the required high tensile force is applied by a capstan drum 14, from which the now stretched wires are guided into a downstream longitudinal wire conditioning 15 for straightening the pre-curved wires, and are then introduced into the welding machine 10 as a horizontal bundle of wires for welding with the transverse wires.

Stretching devices 5, 13 consist in principle of a plurality of bending rollers, through which the wires are deflected from their linear running direction and are stretched (extended) by this bending process. The stroke of the bending rollers (diving depth) is adjusted according to the desired stretching effect (stretching degree) and can typically be controlled centrally.

The degree of stretching corresponding to the cross-section reduction of the wires is usually 4 to 8%. Accordingly, hot-rolled wires must already be rolled to the desired diameter in the rolling mill with a margin, such that after the stretching process they correspond to the wire diameters customary in the market, such as those used in welded meshes.

The iron scale adhering to the hot-rolled wires is broken off during the stretching process, so that perfect resistance welding of such wires is guaranteed (otherwise scale would then act as prohibitor/insulator).

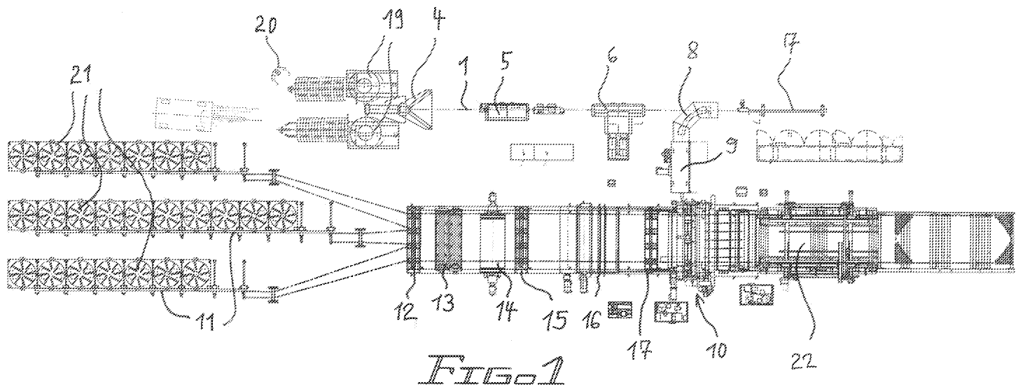

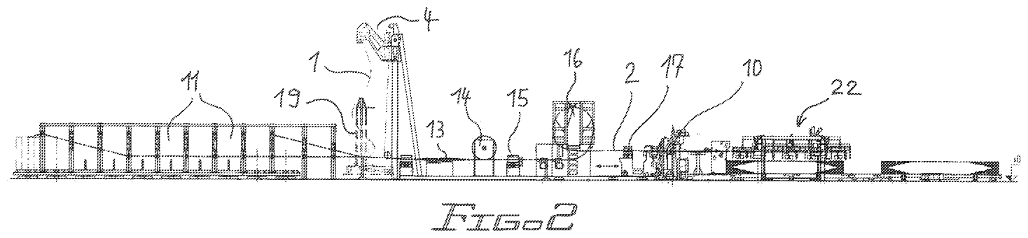

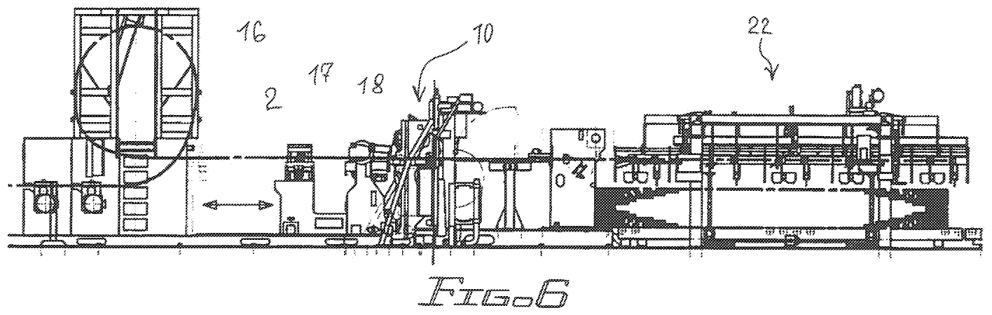

FIGS. 1 to 6 show a typical reinforcement installation with integrated longitudinal wire and transverse wire stretching. Reference 4 represents the vertical overhead pay-off of the transverse wires, reference 5 is the stretching device and reference 6 is the take-off device for applying the required stretching force. Reference 7 represents the wire store, in the form of a large deflection arc, from which the transverse wire feeding device 9 of the welding machine 10 itself draws the wire according to the working cycle. In the region of the transverse wire feeding device 9, the transverse wires are straightened, cut to length and then welded.

The pay-off device for the longitudinal wires is shown as reference 11, wherein these preferably also run vertically overhead and are fed to the stretching device, reference 13, via corresponding wire guides. This stretching device 13 consists of a frame with a stretching tool per longitudinal wire core, in which the wires are guided over multiple adjustable rollers (preferably seven rollers).

The tensile force is generated by the above-mentioned capstan drum 14, over which the wires pass by forming a 360° loop, in order to then be directed horizontally again in a downstream longitudinal wire conditioning 15. The speed of the capstan drum 14 is adjustable according to the working speed of the destination, the welding machine, which usually works with a maximum cycle rate of 150 to 200 welded transverse wires per minute. With typical transverse wire pitches of 100 to 200 mm, the wire speed is 30 to 40 m/min.

The capstan drum 14 is designed in such a way that a separate, delimited chamber is provided for each wire that is guided over this roller, in order to prevent crossovers and thus operational disturbances.

The capstan drum 14 is preferably driven via a worm gear with an average power of 20 to 30 kW.

The welded mats, which are formed by the stretched wires are cut to length in the usual way after the welding process in a region 22 and stacked.

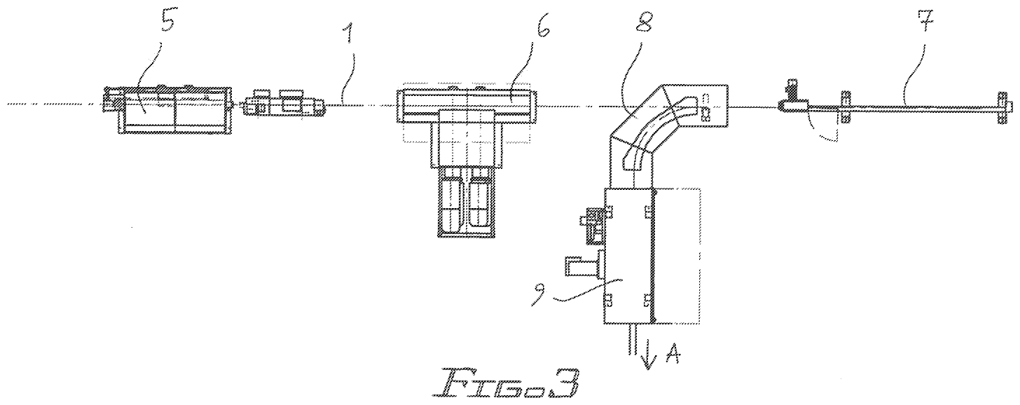

The stretching device 5 (FIG. 3) is formed in a known manner with a plurality of horizontal or vertical rollers, the axes of which are offset from one another and the distances of which can be adjusted for setting the desired degree of stretching. The transverse wire material 1 passes through the stretching device 5 in a wavy manner, is bent back and forth and stretched in the process. The transverse wire material 1 is transferred to the welding machine in the direction of the arrow A after leaving the transverse wire feeding device 9.

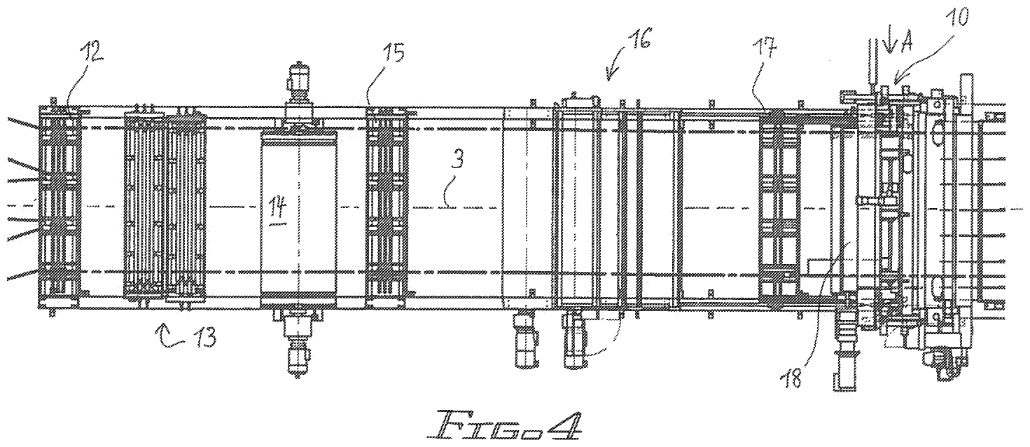

In FIGS. 1, 2 and 5, the pay-off device 11 for the longitudinal wires 2 can also be seen, with a plurality of wire reels 21, which correspond to the plurality of longitudinal wires 2, which are fed to the welding machine 10 in the form of a bundle, with a central and symmetrical distribution around the central axis 3 (FIG. 4) of the same.

The units 5 to 7, through which the transverse wire material 1 passes, are located in the same horizontal plane as the bundle of longitudinal wires 2 drawn from the pay-off device 11, although arranged along a line that is laterally parallel thereto. The storage drums 19 of the pay-off device 4 for the transverse wire material 1 are arranged above this plane. The pay-off device 11 for the longitudinal wires 2 is also arranged above this plane, but at a lower level.

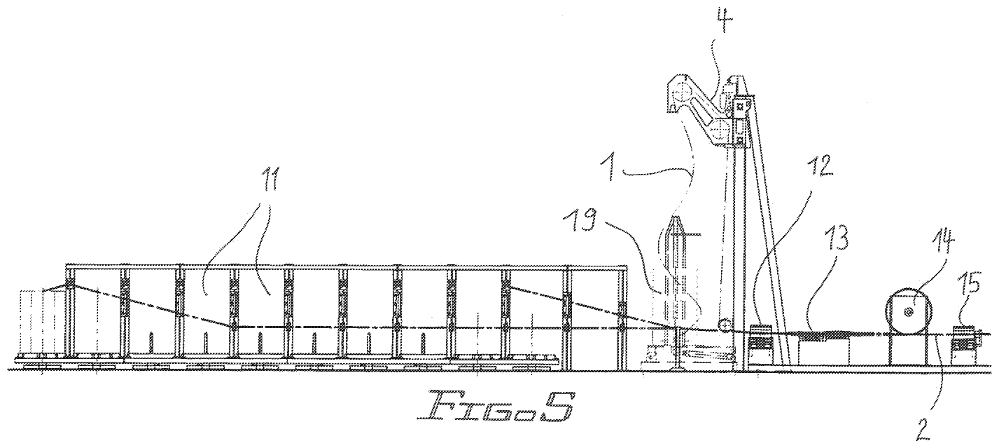

As can be seen from FIGS. 1 and 5—as a detail from FIG. 1—the bundle formed by 25 longitudinal wires 2, which are parallel and spaced from one another, is fed, starting from the pay-off device 11, through a respective wire guide 12, which is provided for each longitudinal wire 2, to a stretching device 13. The invention can equally be used in systems for wire mesh mats with more or fewer than 25 longitudinal wires.

The stretching device 13 differs from the usual design with seven offset horizontal or vertical rollers, the axis distances of which are adjustable, in that each roller is designed with a number of stretching units in the form of work profiles that corresponds to the number of longitudinal wires 2. Then, the bundle of longitudinal wires 2 enters the driven capstan drum 14, which provides the common stretching force for all longitudinal wires 2 of the bundle. This ensures that all longitudinal wires 2 of the group are stretched simultaneously and to the same extent.

According to FIG. 4, there follows a longitudinal wire conditioning 15, which is provided with rollers, similar to the stretching device 13, but which is designed for the simultaneous passage of all longitudinal wires 2, and a loop storage device 16. If the longitudinal wires 2 are fed in too quickly, the loop increases, and if the welding machine 10 requires longitudinal wires 2, the loop becomes smaller. This primarily serves to compensate for the standstill of the bundle of longitudinal wires 2 during the welding process, amounting to a fraction of a second. Starting from the loop storage 16, the group of longitudinal wires 2 runs through a further straightening device 17, which eliminates any bends that are still present. From there, the bundle of longitudinal wires 2 runs to a feeding device 18 which conveys the longitudinal wires 2 to the welding machine 10. Transverse wires coming from the direction of the arrow A (FIG. 4) are also fed to the welding machine.

What is claimed is:

1-14. (canceled)

15. A method for the continuous production of mesh mats made of steel wire having a bundle of parallel longitudinal wires that are welded to transverse wires extending in a manner spaced apart from one another, wherein hot- or cold-rolled wire material is used as the longitudinal and transverse wires, wherein the longitudinal wires are stretched in a stretching device while being fed to the welding process, wherein the longitudinal wires are drawn through the stretching device by means of a capstan drum, and wherein the transverse wire material is also stretched in a separate stretching device while being fed to the welding process.

16. The method of claim 15, wherein all the longitudinal wires form a bundle while being fed to the welding process, in which they are brought parallel to one another in a plane and are simultaneously stretched in this arrangement in the stretching device.

17. The method of claim 15, wherein the transverse wire material is drawn through the stretching device by means of a take-off device.

18. The method of claim 15, wherein the transverse wire material and the longitudinal wires are straightened after stretching.

19. The method of claim 15, wherein the stretching process taking place on the transverse wire material is carried out on wire held ready on two storage drums of a pay-off device, wherein the wire is alternately drawn off from the two storage drums used alternately and the free ends of the drawn off wire are welded, so that the stretching process takes place on a continuous wire.

20. The method of claim 15, wherein the stretched transverse wire material is guided through a compensating store and a deflection arc and is straightened only immediately before it is fed to a welding machine and is cut in the shape of the individual transverse wires.

21. An installation for carrying out the method of claim 15 for the continuous production of mesh mats made of steel wire welded at the crossing points, with a pay-off device with a number of take-off drums corresponding to the plurality of parallel longitudinal wires which are fed to a welding machine in the form of a bundle, wherein the bundle can be fed to a welding machine in a horizontal guideway centrally arranged and symmetrically distributed around the central axis of the same, as well as with a pay-off device for the transverse wire material of the mesh, which can also be fed to the welding machine, wherein the transverse wire material run off from the pay-off device can be fed to the region immediately in front of the welding machine in a separate guideway of the welding machine, wherein a respective stretching device is arranged in the guideways of the longitudinal wires and of the transverse wire material and wherein, when viewed in the direction of motion of the longitudinal wires, a capstan drum is arranged behind the stretching device for the longitudinal wires, through which capstan drum the longitudinal wires can be drawn through the stretching device.

22. The installation of claim 21, wherein the bending rollers of the stretching device for the transverse wire material can be adjusted.

23. The installation of claim 21, wherein the pay-off device for the transverse wire material comprises two storage drums which are used alternately and a welding device for welding the ends of the transverse wire material alternately drawn off from the storage drums, so that the stretching process can be carried out on a continuous transverse wire material.

24. The installation of claim 21, wherein the guideway for the transverse wire material is arranged laterally offset up to immediately in front of the region of the welding machine and parallel to the horizontal guideway of the longitudinal wires.

25. The installation of claim 21, wherein the take-off devices in the form of capstan drums are followed by a longitudinal wire conditioning or a straightening device for the transverse wire material integrated in the transverse wire feeding device.

26. The installation of claim 21, wherein the stretching device for the longitudinal wires is preceded by a separate wire guide for each longitudinal wire, wherein a separate stretching unit with rollers successively engaging each longitudinal wire on opposite sides is provided for each longitudinal wire of the bundle, which rollers are combined to form respective multiple rollers, in order to simultaneously apply the same tensile force to each longitudinal wire.

27. The installation of claim 21, wherein the capstan drum has a roller with chambers for each longitudinal wire, in order to prevent crossover.

28. The installation of claim 21, wherein a device for cutting the transverse wire material into the individual transverse wires is integrated in the transverse wire feeding device.
